(19) United States
(12) Patent Application Publication
(10) Pub. No.: US 2023/0339327 A1
(43) Pub. Date: Oct. 26, 2023

(54) SCREEN ASSEMBLY FOR AN INTERIOR OF A VEHICLE, METHOD FOR CONTROLLING A POSITION OF A SCREEN COMPONENT IN AN INTERIOR OF A VEHICLE, DATA PROCESSING APPARATUS, AND SCREEN SYSTEM FOR AN INTERIOR OF A VEHICLE

(71) Applicant: Volvo Car Corporation, Göteborg (SE)

(72) Inventors: Alborz SEDAGHAT AMOLI, Göteborg (SE); Oskar BLANK, Göteborg (SE)

(21) Appl. No.: 18/127,873

(22) Filed: Mar. 29, 2023

(30) Foreign Application Priority Data
Apr. 21, 2022 (EP) 22169204

(51) Int. Cl. B60K 37/02

(52) U.S. Cl. CPC B60K 37/02; B60K 2370/149; B60K 2370/21; B60K 2370/39; B60K 2370/152; B60K 2370/67; B60K 2370/682; B60K 2370/55; B60K 2370/741; B60K 2370/774

(57) ABSTRACT

A screen assembly for an interior of a vehicle. The screen assembly includes a base component being configured for being arranged in an interior of an instrument panel or in an interior of a center console of the vehicle. Moreover, the screen assembly includes a screen component including a screen unit being configured for displaying information for a user of the vehicle. A translational guiding means is kinematically arranged between the screen component and the base component such that the screen component is translationally movable relative to the base component. Moreover, a first rotational guiding means is kinematically arranged between the screen component and the base component such that the screen component is tiltable. Additionally, a method for controlling a position of a screen component in an interior of a vehicle is presented. Furthermore, a data processing apparatus and a screen system for an interior of a vehicle are explained.

### CROSS-REFERENCE TO RELATED APPLICATION

The present disclosure claims the benefit of priority of co-pending European Patent Application No. 22 169 204.9, filed on Apr. 21, 2022, and entitled “SCREEN ASSEMBLY FOR AN INTERIOR OF A VEHICLE, METHOD FOR CONTROLLING A POSITION OF A SCREEN COMPONENT IN AN INTERIOR OF A VEHICLE, DATA PROCESSING APPARATUS, AND SCREEN SYSTEM FOR AN INTERIOR OF A VEHICLE,” the contents of which are incorporated in full by reference herein.

### TECHNICAL FIELD

The present disclosure relates to a screen assembly for an interior of a vehicle. Furthermore, the present disclosure is directed to a method for controlling a position of a screen component in an interior of a vehicle. The present disclosure also relates to a data processing apparatus. Moreover, the present disclosure is directed to a screen system for an interior of a vehicle.

### BACKGROUND

The interior of modern vehicles such as cars and trucks includes at least one screen for displaying information to a user of the vehicle, e.g. a driver or a passenger. Since information being displayed by the screen may be of relevance while the vehicle is travelling, it is important that at least the driver of the vehicle is able to clearly see the information on the screen without being distracted.

### SUMMARY

It is an objective of the present disclosure to facilitate the transmission of information to the driver and other users of the vehicle.

According to a first aspect, there is provided a screen assembly for an interior of a vehicle. The screen assembly includes a base component being configured for being arranged in an interior of an instrument panel or in an interior of a center console of the vehicle. Moreover, the screen assembly includes a screen component including a screen unit being configured for displaying information for a user of the vehicle. Furthermore, the screen assembly includes a translational guiding means being kinematically arranged between the screen component and the base component such that the screen component is translationally movable relative to the base component along a translation direction. The screen assembly also includes a first rotational guiding means being kinematically arranged between the screen component and the base component such that the screen component is tiltable relative to the base component around a tilting axis. The first rotational guiding means and the vertical guiding means are independent from one another and the tilting axis is perpendicular to the translation direction. Consequently, the screen component can assume a position along the translation direction and a position around the tilting axis. The translational position and the tilting position are independent from one another. Thus, the screen component can be positioned in the interior of the vehicle such that the displayed information is easily and clearly visible by a user of the vehicle, e.g. the driver or the passenger. In this context, the position of the screen component may be adapted to a size of the user and/or a sitting position of the user. More generally speaking, the screen component can be positioned in the focus of the user, e.g. the driver or the passenger. Consequently, the user can easily and comfortably perceive the displayed information without the need to perform big movements. Moreover, the screen component can be arranged in the interior of the vehicle such that reflections on the screen are avoided or reduced. The same applies to undesired reflections of information being provided on the screen on other components of the vehicle. This also facilitates the perception of the displayed information by the user.

In the present context, being kinematically arranged between the screen component and the base component means being kinematically arranged between at least a portion of the screen component and at least a portion of the base component. Analogously, a relative movement between the screen component and the base component is to be understood as a relative movement of at least a portion of the screen component with respect to at least a portion of the base component.

It is noted that a user of the vehicle not only includes the driver but also a front seat passenger and a back seat passenger.

In an example, the direction of translation may be generally vertical if the screen assembly is mounted in the vehicle. The tilting axis may be substantially horizontal. With respect to a forward driving direction of the vehicle, the tilting axis may extend from left to right in the interior vehicle. The surface of the screen on which the information is displayed may generally face rearward with respect to the forward driving direction.

In another example, the translational guiding means may be used to fully or partially retract the screen component inside the instrument panel or the center console. The screen component may be fully retracted in a situation in which the screen unit is not needed. In doing so, unnecessary distraction by the screen unit is avoided. The partially retracted position may be used if only a limited amount of information needs to be displayed to the user. This has the effect that the user can easily find the relevant information and is not distracted by non-relevant information or portions of the screen unit showing other content than the relevant information. More generally speaking, the portion of the screen unit which extends over the instrument panel or center console can be adapted to the amount of information to be displayed.

In an example, the screen assembly may further include a translational drive unit being coupled to the screen component and being configured for moving the screen component with respect to the base component along the translation direction. The drive unit may be configured to move the screen component automatically. Thus, the screen component may be positioned in the interior of the vehicle without the need for the user to physical move the screen component. The screen component may be either moved following a signal being provided by an action of the user, e.g. pushing a button or tilting a lever. Alternatively, the screen component may be moved in a fully automatic manner without any action being performed by the user. Both alternatives enhance the comfort of the user. Moreover, driving safety is enhanced if as little action as possible is required by the user.

In an example, the translational drive unit may include a rack and pinion mechanism and an electric motor unit being coupled to the pinion. Such a mechanism is reliable and precise at the same time. Thus, the screen component may be positioned along the translation direction in a reliable and precise manner.

In another example, the translational drive unit may include two rack and pinion mechanisms. In this case, the two rack and pinion mechanisms are arranged at opposite ends of the screen unit respectively. Such a translational drive unit is particularly stable.

It is noted that the rack and pinion mechanism may also provide a translational guiding functionality. Thus, the rack and pinion mechanism may also form part of the translational guiding means.

According to an example, the screen assembly may further include a first rotational drive unit being coupled to the screen component and being configured for tilting the screen component with respect to the base component around the tilting axis. The tilting may be performed in an automatic manner. The screen component may, thus, be either tilted around the tilting axis following a signal being provided by an action of the user, e.g. pushing a button or tilting a lever. Alternatively, the screen component may be tilted in a fully automatic manner without any action being performed by the user. Both alternatives enhance the comfort of the user. Moreover, driving safety is enhanced if as little action as possible is required by the user.

The first rotational drive unit may include a rotational actuator such as an electric motor. The electric motor may be coupled with a gear mechanism.

In a further example, the screen assembly may include a second rotational guiding means being kinematically arranged between the screen component and the base component such that the screen component is rotatable relative to the base component around a rotation axis. The second rotational guiding means, the first rotational guiding means and the translational guiding means are independent from one another and the rotation axis is perpendicular to the tilting axis. The second rotational guiding means adds a degree of freedom to the positioning of the screen component in an interior of the vehicle. This additional degree of freedom is independent from the translational position and the position around the tilting axis. Thus, the screen component can be positioned in the interior of the vehicle such that the displayed information is easily and clearly visible by a user of the vehicle, e.g. the driver or the passenger. Again, the position of the screen component may be adapted to a size of the user and/or a sitting position of the user. More generally speaking, the screen component can be positioned in the focus of the user, e.g. the driver or the passenger. Due to the movability of the screen component, it can be specifically arranged in the focus of the user. Consequently, the user can easily and comfortably perceive the displayed information without the need to perform big movements. Moreover, the screen component can be arranged in the interior of the vehicle such that undesired reflections on the screen or undesired reflections of information being displayed on the screen on other components of the vehicle are avoided or reduced. This also facilitates the perception of the displayed information by the user.

As before, being kinematically arranged between the screen component and the base component means being kinematically arranged between at least a portion of the screen component and at least a portion of the base component. Analogously, a relative movement between the screen component and the base component is to be understood as a relative movement of at least a portion of the screen component with respect to at least a portion of the base component.

In an example, the screen assembly may further include a second rotational drive unit being coupled to the screen component and being configured for rotating the screen component with respect to the base component around the rotation axis. The second rotational drive unit may be configured to rotate the screen component automatically. The screen component may, thus, be either rotated around the rotation axis following a signal being provided by an action of the user, e.g. pushing a button or tilting a lever. Alternatively, the screen component may be rotated in a fully automatic manner without any action being performed by the user. Both alternative enhance the comfort of the user. Moreover, driving safety is enhanced if as little action as possible is required by the user.

According to a second aspect there is provided a method for controlling a position of a screen component in an interior of a vehicle, including:
receiving information describing a position of at least one eye of a driver being located in the interior of the vehicle,
determining a target position for the screen component as a function of the position of the at least one eye, wherein the target position is arranged within a field of view of the driver, and
requesting the screen component to move to the target position.

In this context, the target position includes a position component along the translation direction and around the tilting axis. Optionally, the target position also includes a position component around the rotation axis. When applying this method, the screen component can be placed in the interior of the vehicle such that it is in the focus of the driver, i.e. such that the driver can see the information displayed on the screen unit with great ease and comfort. The same may apply to a passenger. This also enhances driving security if the driver needs to see the information while driving. As has already been explained before, the target position can also be chosen such that undesired reflections are avoided or reduced.

As has already been explained also the portion of the screen unit which extends from the instrument panel or the center console can be adapted to the amount of information to be displayed.

The information describing a position of at least one eye of the driver may be provided by a so-called eye tracking unit or eye tracking system. Such units or systems are known as such.

In an example, the target position is characterized in that a height difference between the position of the at least one eye and the screen component is at least one of below an upper height difference threshold and above a lower height difference threshold. Thus, the target position of the screen is adapted to an eye level of the driver. Consequently, the target position may be adapted depending on a size and sitting position of the driver. In this context, it may be an objective to position the screen component such that the height difference is minimal.

In an example, the target position is characterized in that a vision angle between a horizontal direction and a vision direction connecting the at least one eye and a center of the screen unit of the screen component is at least one of below an upper vision angle threshold and above a lower vision angle threshold. Thus, the target position of the screen component lies within a focus of the driver or the information displayed on the screen unit is easily visible for the driver. Also in this respect, the target position depends on a size of the driver and a sitting position of the driver.

According to an example, the target position is characterized in that a reflection angle between the screen unit of the screen component and a windshield is at least one of below an upper reflection angle threshold and above a lower reflection angle threshold. Consequently, undesired reflections are avoided or at least reduced. Consequently, the level of distraction for a driver is also reduced.

In another example, the target position may be limited by the kinematic limits of at least one of the translational guiding means, the first rotational guiding means and the second rotational guiding means. Thus, the guiding means impose certain boundaries for the target position.

In a further example, remaining components inside the interior of the vehicle may impose further limitations on the target position. For example, the windshield or portions of the instrument panel or the center console may impose such limitations. In other words, the target position must be chosen such that the screen component and other parts of the screen assembly do not collide with other elements in the interior of the vehicle.

In an example, the method may further include receiving information describing a position of at least one hand of the driver being located in the interior of the vehicle, and determining the target position for the screen component as a function of the position of the at least one hand. Thus, the target position of the screen component may be determined such that the hand does not obstruct the driver's line of sight towards the screen component. In a case in which based on the position of the hand also a position of a driver's arm is derived, this also applies to the driver's arm. Consequently, the information displayed on the screen unit may be easily and comfortably seen by the driver.

The information describing the position of the hand may be provided by a so-called hands-on detector. Such a hands-on detector usually is configured to detect a driver's hand on the steering wheel.

Additionally or alternatively, the position of the hand may be provided by a so-called driver monitoring system. Such a system may include a camera being configured to capture images of the driver. These images may be analyzed using for example an object recognition technique. Consequently, parts of the driver's body, such as the hands or arms may be detected and a corresponding position may be derived from the images captured by the driver monitoring system.

In another example, the method may include receiving information describing the presence of a front seat passenger, and determining the target position of the screen component as a function of the presence of the front seat passenger. In such a case, the target positon may be determined such that both the driver and the front seat passenger can see the information displayed on the screen unit.

The information on the presence of a front seat passenger may for example be provided by a sensor arranged in the front passenger seat.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may include one or more of a processor, a memory, a data interface, or the like.

According to a third aspect, there is provided a data processing apparatus. The data processing apparatus includes a first communication interface being configured to provide a positioning request to the screen component. Moreover, the data processing apparatus includes a second communication interface being configured to receive information characterizing a position of at least one eye of a driver. Additionally, the data processing apparatus includes means for carrying out the method according to the present disclosure. Such a data processing apparatus may also be designated as a control unit for a screen assembly. Thus, using such a data processing apparatus, the screen component can be placed in the interior of the vehicle such that it is in the focus of the driver, i.e. such that the driver can see the information displayed on the screen unit with great ease and comfort. This also enhances driving security if the driver needs to see the information while driving. As has already been explained before, the target position can also be chosen such that undesired reflections are avoided or reduced.

In an example, a computer program product is provided which includes instructions which, when the program is executed by a computer, cause the computer to carry out the method of the present disclosure.

In another example, a computer-readable storage medium is provided which includes instructions which, when executed by a computer, cause the computer to carry out the method of the present disclosure.

In an example, the data processing apparatus may further include a third communication interface being configured to receive information characterizing a position of at least one hand of the driver. Consequently, the information characterizing the position of the at least one hand of the driver can be provided to the data processing apparatus. Based thereon, the target position of the screen component can be determined such that a line of sight is not obstructed by the at least one hand of the driver or a corresponding arm.

In a further example, the data processing apparatus may further include a fourth communication interface being configured to receive information describing a presence of a front seat passenger. As has already been explained, based on such information, the target position of the screen component can be determined such that both a driver and a front seat passenger can see the information displayed on the screen unit with high ease and comfort.

According to a fourth aspect, there is provided a screen system for an interior of a vehicle. The screen system includes a screen assembly according to the present disclosure and a data processing apparatus according to the present disclosure, wherein the data processing apparatus is coupled to the screen assembly such that a position of a screen component of the screen assembly is controllable by the data processing apparatus. Thus, the screen component can automatically be located in the interior of the vehicle such that it is in the focus of the driver, i.e. such that the driver can see the information displayed on the screen unit with great ease and comfort. At the same time driving security is enhanced and undesired reflections are avoided or reduced.

In an example, the screen system further includes an eye tracking unit. The eye tracking unit is configured to provide information characterizing a position of at least one eye of a driver. The eye tracking unit is communicatively connected to the data processing apparatus via the second communication interface of the data processing apparatus. Consequently, a position of the screen component can be chosen as a function of the position of the at least one eye of the driver. This may be done in an automatic manner. Thus, the screen component always is in the visual focus of the driver, such that the driver can see the information displayed on the screen unit with great ease and comfort.

It is noted that, of course, the target position of the screen component and, thus, the position of the screen component in the interior of the vehicle can also be adjusted while driving. Thus, the position can be adapted to a changing sitting position of the driver or to a changing incidence of light leading to changing reflection conditions. A changing sitting position also may lead to a changing position of the at least one eye of the driver. In other words, perfect viewing conditions for the driver are maintained even though the sitting position and the incidence of light may change.

Moreover, the above described systems and methods may also be used in a vehicle which is able to drive in a partly or fully autonomous manner. In a situation in which the vehicle changes from a manual driving mode to a partly or fully autonomous driving mode, the user, especially the driver, may alter its sitting position and for example assume a more relaxed sitting position while the partly or fully autonomous driving mode is active. The position of the at least one eye of the driver is altered accordingly. In such a situation, the position of the screen component may be automatically adapted to the altered sitting position and the altered position of the eye. Thus, the driver may always have good viewing condition with respect to the information being displayed on the screen unit.

It should be noted that the above examples may be combined with each other irrespective of the aspect involved.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings.

FIG. 1 shows a screen system according to the present disclosure in a topview, wherein the screen system is arranged in an interior of a vehicle and includes a screen assembly according to the present disclosure and a data processing apparatus according to the present disclosure, the data processing apparatus being configured to carry out a method according to the present disclosure,

FIG. 2 shows the screen system of FIG. 1 in a lateral view in plane II-II of FIG. 1,

FIG. 3 shows the screen assembly of FIGS. 1 and 2 in a more detailed view, wherein the screen component is fully extended over an instrument panel,

FIG. 4 shows the screen assembly of FIG. 3, wherein the screen component is partly extended over the instrument panel,

FIG. 5 shows the screen assembly of FIGS. 3 and 4 without a representation of the instrument panel,

FIG. 6 shows the screen assembly in a lateral view, wherein the screen component is in a first tilted state,

FIG. 7 shows the screen assembly in a lateral view corresponding to FIG. 6, wherein the screen component is in a second tilted state, and

FIG. 8 illustrates steps of the method according to the present disclosure.

The figures are merely schematic representations and serve only to illustrate examples of the disclosure. Identical or equivalent elements are in principle provided with the same reference signs.

### DETAILED DESCRIPTION

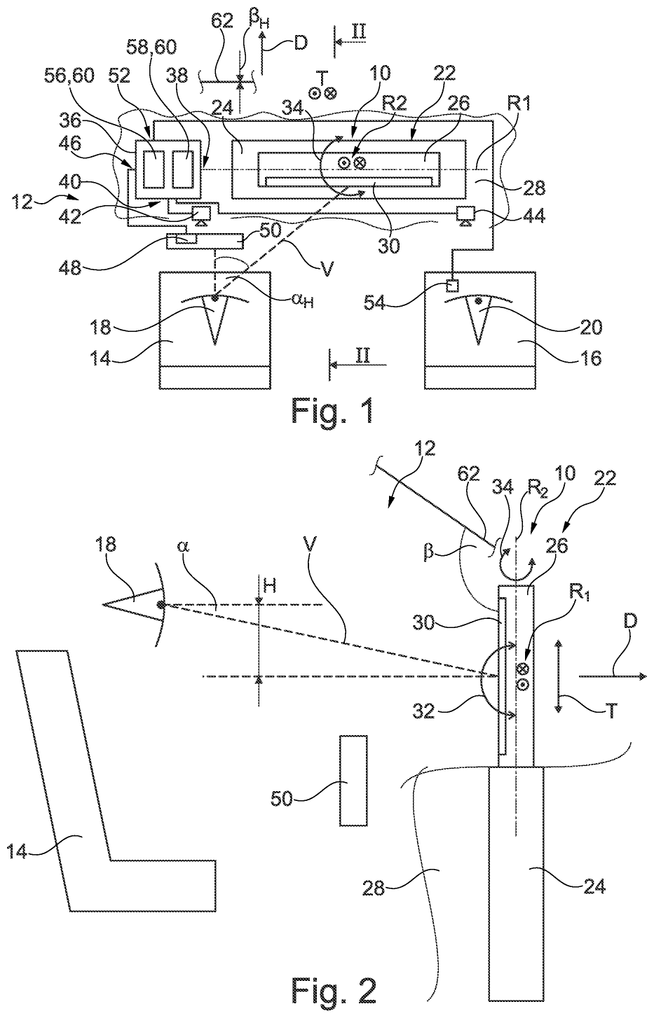

FIGS. 1 and 2 show a screen system 10. The screen system 10 is arranged in an interior 12 of a vehicle. The interior 12 also includes a driver seat 14 and a passenger front seat 16. A driver sitting on the driver seat 14 is represented by one eye 18. A front seat passenger sitting on a passenger front seat 16 is represented by one eye 20.

The screen system 10 includes a screen assembly 22 with a base component 24 and a screen component 26. The base component 24 is arranged in an interior of an instrument panel 28 of the vehicle.

In the example of FIGS. 1 and 2, the screen component 26 protrudes over the instrument panel 28. The screen component 26 includes a screen unit 30 being configured for displaying information for a user of the vehicle, i.e. for the driver being represented by eye 18 and the front seat passenger being represented by eye 20. The screen component 26 is movable with respect to the base component 24 in several respects.

First, the screen component 26 is translationally movable relative to the base component 24 along a translation direction T.

In the example shown in FIGS. 1 and 2, the translation direction T is oriented substantially vertically within the interior 12 of the vehicle.

Second, the screen component 26 is tiltable relative to the base component 24 around a tilting axis R1.

In the example shown in FIGS. 1 and 2, the tilting axis R1 is oriented substantially horizontally within the interior 12 of the vehicle. At the same time, the tilting axis R1 substantially extends from left to right in the interior 12 of the vehicle with respect to a forward driving direction D. The corresponding tilting movement is illustrated by arrow 32.

Third, the screen component 26 is rotatable relative to the base component 24 around a rotation axis R2.

In the example shown in FIGS. 1 and 2, the rotation axis R2 is oriented substantially vertically within the interior 12 of the vehicle. The corresponding rotational movement is illustrated by arrow 34.

Thus, the tilting axis R1 is perpendicular to the translation direction T and the rotation axis R2 is perpendicular to the tilting axis R1.

The tilting of the screen component 26 around tilting axis R1 can also be seen in FIGS. 6 and 7. The rotational movement around the tilting axis R1, the rotational movement around the rotation axis R2 and the translational movement along the translation direction T may be performed independent from one another as will be explained in more detail below.

The screen system 10 also includes a data processing apparatus 36. The data processing apparatus 36 is coupled to the screen assembly 22 such that a position of the screen component 26 of the screen assembly 22 is controllable by the data processing apparatus 36. To this end, the data processing apparatus 36 includes a first communication interface 38 which is configured to provide a positioning request to the screen assembly 22, more precisely to the screen component 26.

The screen assembly 22 is communicatively connected to the data processing apparatus 36 via the first communication interface 38. Moreover, the data processing apparatus 36 includes a second communication interface 40 being configured to receive information characterizing a position of at least one eye 18 of the driver.

In the example, a first eye tracking unit 42 is connected to the data processing apparatus 36 via the second communication interface 40. The first eye tracking unit 42 is configured to provide information characterizing the position of the eye 18.

Furthermore, also a second eye tracking unit 44 is connected to the data processing apparatus 36 via the second communication interface 40. The second eye tracking unit 44 is configured to provide information characterizing the position of the eye 20, i.e. at least one eye of the front seat passenger. Thus, the second communication interface 40 is also configured to receive information characterizing a position of at least one eye 20 of the front seat passenger.

The data processing apparatus 36 further includes a third communication interface 46 which is configured to receive information characterizing a position of at least one hand of the driver.

In the example, a hands-on detector 48 is connected to the data processing apparatus 36 via the third communication interface 46. The hands-on detector 48 is arranged in a steering wheel 50 of the vehicle and is configured to provide information characterizing the position of at least one hand of the driver.

Furthermore, the data processing apparatus 36 includes a fourth communication interface 52 configured to receive information describing a presence of the front seat passenger. In the example, a seat detector 54 is connected to the data processing apparatus 36 via the fourth communication interface 52. The seat detector 54 is configured to provide information describing the presence of the front seat passenger.

Moreover, the data processing apparatus 36 includes a data storage unit 56 and a data processing unit 58. Using the data processing apparatus 36, more precisely the data storage unit 56 and the data processing unit 58, a method for controlling a position of the screen component 26 in the interior 12 of the vehicle can be performed. Thus, the data storage unit 56 and the data processing unit 58 are means 60 for carrying out the method for controlling a position of the screen component 26 in the interior 12 of the vehicle.

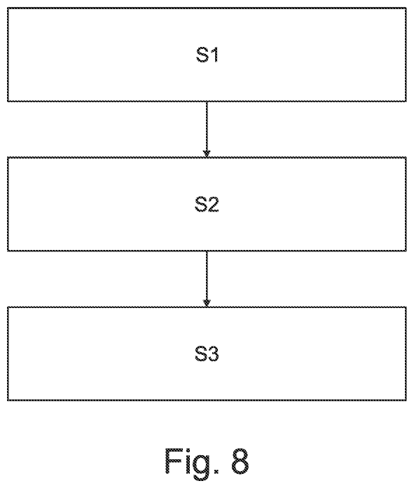

The method is illustrated in FIG. 8. A first step S1 of the method includes receiving information describing a position of at least one eye 18 of the driver. This information is provided by the first eye tracking unit 42 as has already been explained above. Moreover, in the present example, the first step S1 includes receiving information describing a position of at least one eye 20 of the front seat passenger, if present. This information is provided by the second eye tracking unit 44 as has already been explained above. In the present example, in the first step S1 also information describing a position of at least one hand of the driver is received. As has already been explained, this information is provided by the hands-on detector 48. Furthermore, the first step S1 of the present example includes receiving information describing the presence of a front seat passenger. This information is provided by the seat detector 54 which has already been explained above.

A second step S2 of the method includes determining the target position for the screen component 26. The target position is a function of the information received in the first step. In more detail, the target position is determined as a function of the position of the at least one eye 18 of the driver. The target position is also determined as a function of the position of the at least one eye 20 of the front seat passenger, if present. Furthermore, the target position is determined as a function of the position of the at least one hand. Also the target position is determined as a function of the presence of the front seat passenger. In the present example, it is assumed that no front seat passenger is present. Consequently, the target position has to be within a field of view of the driver only. In this context, the target position is determined such that a height difference H between the position of the driver's eye 18 and the screen component 26 lies between a pre-defined lower height difference threshold and a pre-defined upper height difference threshold.

The height difference H is calculated between a center of the driver's eye 18 and a center of the screen unit 30 of the screen component 26 (cf. FIG. 2). The lower height difference threshold may be for example 10 cm, 15 cm or 20 cm. Generally, a low height difference means that the driver is able to comfortably see the screen component 26 and the information displayed thereon. However, the driver also needs to be able to see the environment, e.g. other road users, which are located behind the screen component 26 when regarded from the driver's position. The upper height difference may be 25 cm, 30 cm or 35 cm. the upper height difference is chosen such that the driver still can comfortably see the screen component 26 and the information displayed thereon. If the height difference is too large, the driver needs to bend his neck to a large extent in order to be able to see the displayed information. This is not comfortable for the driver.

Moreover, the target position is characterized in that a vision angle α between a horizontal direction and a vision direction V connecting the driver's eye 18 and a center of the screen unit 30 lies between a lower vision angle threshold and an upper vision angle threshold. The lower vision angle threshold may be 2 degrees, 5 degrees or 8 degrees. The upper vision angle threshold may be 10 degrees, 15 degrees or 20 degrees.

As has already been explained in connection with the height difference H, also the vision angle α needs to be chosen such that on the one hand, the driver can comfortably look beyond the screen component 26 and the screen unit 30. On the other hand, the driver needs to be able to comfortably see information being displayed on the screen unit 30. Such a target position guarantees good viewing conditions for the driver. This means that the driver can see information being displayed on the screen unit 30 easily and comfortably.

Moreover, the target position is determined such that a reflection angle β between the screen unit 30 and a windshield 62 lies between a lower reflection angle threshold and an upper reflection angle threshold. This has the effect that both undesired reflections in the windshield 62 and undesired reflections on the screen unit 30 are avoided or reduced. Consequently, the driver is not distracted by such reflections.

It is noted that the vision angle α and the reflection angle β have been explained in connection with FIG. 2 which shows a lateral view only. However, the vision angle α and the reflection angle β, of course, may also have angular components being visible in the top view of FIG. 1 only. These components are denoted α_{H} and β_{H}. In the example of FIG. 1, β_{H} is 0 degrees. The above explanations concerning the vision angle and the reflection angle of course also apply to the components α_{H} and β_{H}.

In a third step S3 of the method, the screen component is requested to move to the target position. This is done by sending a corresponding control signal from the first communication interface 38 to the screen assembly 22. In this context, the target positon may relate to a position of the screen component 26 in which a front surface of the screen unit 30 is perpendicular to the viewing direction V of the driver. It is noted that in a case in which the presence of a front seat passenger is detected, the target position, of course, needs to be determined such that also the front seat passenger is able to see information being displayed on the screen unit 30.

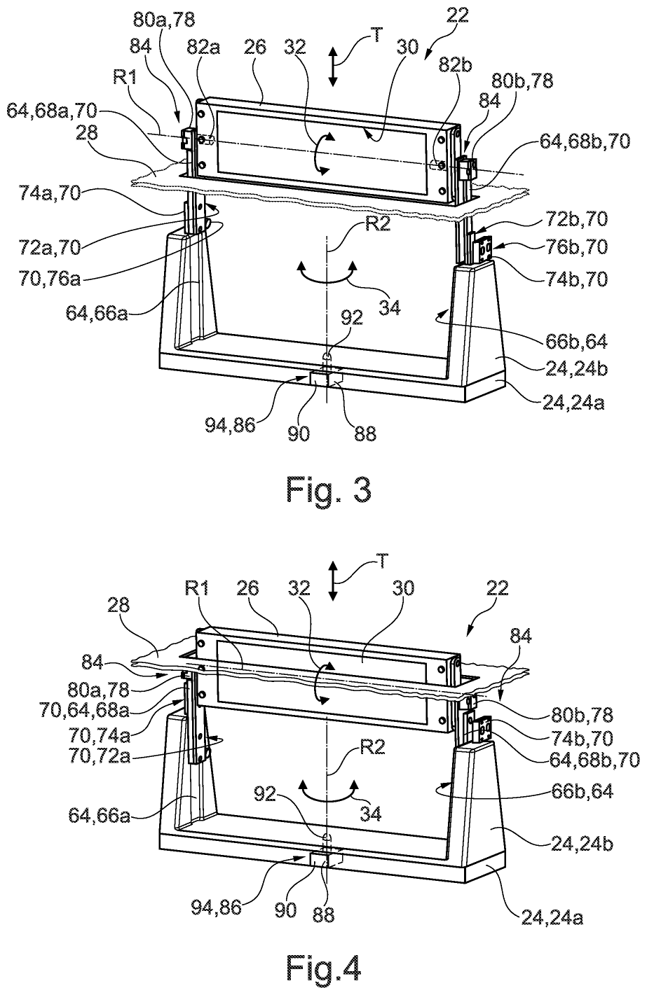

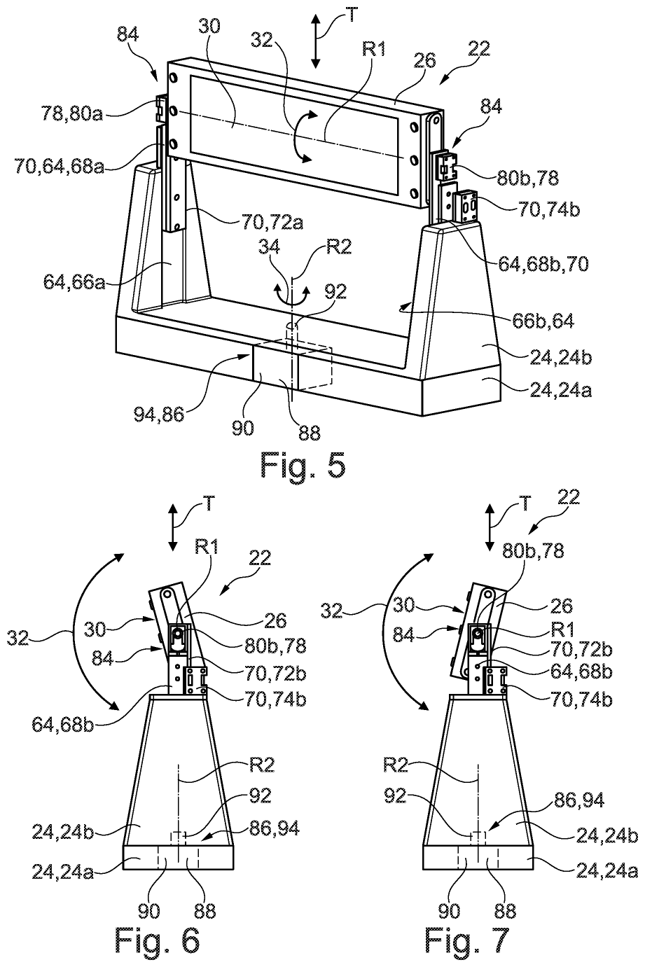

The screen assembly 22 will now be explained in more detail in connection with FIGS. 3 to 7.

The base component 24 is composed of a first, plate shaped part 24a and a second, U-shaped part 24b.

The screen component 26 is supported on the base component 24, more precisely on the second part 24b thereof, via a translational guiding means 64.

The translational guiding means 64 is kinematically arranged between the screen component 26 and the base component 24 and, thus, makes it possible to move the screen component 26 with respect to the base component 24 along the translation direction T. The translational guiding means 64 includes two slots 66a, 66b which hare arranged at an interior side of the legs of the U-shape of the second part 24b respectively. Moreover, the translational guiding means 64 includes two guiding arms 68a, 68b which are guided in the slots 66a, 66b respectively. An end of each of the guiding arms 68a, 68b is supported on the screen component 26.

Thus, the screen component 26 can be moved relative to the base component 24 by sliding the guiding arms 68a, 68b in the respective slots 66a, 66b.

The screen assembly 22 also includes a translational drive unit 70 being coupled to the screen component 26 and being configured for automatically moving the screen component 26 with respect to the base component 24 along the translation direction T. The translational drive unit 70 includes two toothings 72a, 72b which are arranged on lateral sides of the guiding arms 68a, 68b respectively. The guiding arms 68a, 68b thus form racks.

Moreover, the translational drive unit 70 includes two motor units 74a 74b. Each of the motor units 74a, 74b includes an electric motor and a pinion 76a, 76b being mounted to an output shaft of the motors respectively.

The arms 68a, 68b forming racks and the pinions 76a, 76b form a rack and pinion mechanism.

Thus, the screen component 26 may be automatically moved along the translation direction T by operating the motor units 74a, 74b.

The screen assembly 22 also includes a first rotational guiding means 78 being kinematically arranged between the screen component 26 and the base component 24 such that the screen component 26 is tiltable relative to the base component 24 around the tilting axis R1.

The screen component 26 is mounted on each of the guiding arms 68a, 68b via a motor unit 80a, 80b respectively.

Each of the motor units 80a, 80b includes a motor shaft 82a, 82b and the screen component 26 is connected to the motor shafts 82a, 82b.

Thus, the screen component 26 can be tilted relative to the base component 24 by turning the motor shafts 82a, 82b with respect to the remaining parts of the motor units 80a, 80b.

The screen component 26 can be automatically tilted by actuating the motor units 80a, 80b. Thus, the motor units 80a, 80b also form a first rotational drive unit 84.

Furthermore, the screen assembly 22 includes a second rotational guiding means 86 being kinematically arranged between the screen component 26 and the base component 24. More precisely, the second rotational guiding means 86 is arranged between the first part 24a of the base component 24 and the second part 24b of the base component 24.

Using the second rotational guiding means 86, the screen component 26 is rotatable relative to the first part 24a of the base component 24 around the rotation axis R2.

The first part 24a and the second part 24b are connected via a motor unit 88. The motor unit 88 includes a motor body 90 and a motor shaft 92.

In the present example, the motor body 90 is arranged in the first part 24a and the motor shaft 92 is connected to the second part 24b.

Thus, the screen component 26 can be rotated around rotation axis R2 by turning the motor shaft 92 relative to the motor body 90. This can be done automatically by actuating the motor unit 88. Thus, the motor unit 88 also forms a second rotational drive unit 94 for automatically rotating the screen component 26 with respect to the base component 24 around the rotation axis R2.

It is noted that the translational drive unit 70, the first rotational drive unit 84, and the second rotational drive unit 94 may be operated independent form one another. Consequently, the rotational movement around the tilting axis R1, the rotational movement around the rotation axis R2 and the translational movement along the translation direction T may be performed independent from one another.

As can be seen from a comparison of FIGS. 3 and 4, the translational guiding means 64 and the translational drive unit 70 may also be used to make the screen component 26 extend fully or partially over the instrument panel 28. Thus, the portion of the screen unit 30 which can be seen may be adapted to an amount and a type of information to be displayed to the driver or the front seat passenger.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

1. A screen assembly for an interior of a vehicle, the screen assembly comprising:
a base component configured for being arranged in an interior of an instrument panel or in an interior of a center console of the vehicle;
a screen component comprising a screen unit configured for displaying information for a user of the vehicle;
a translational guiding means kinematically arranged between the screen component and the base component such that the screen component is translationally movable relative to the base component along a translation direction (T); and
a first rotational guiding means kinematically arranged between the screen component and the base component such that the screen component is tiltable relative to the base component around a tilting axis (R1);
wherein the first rotational guiding means and the translational guiding means are independent from one another and the tilting axis (R1) is perpendicular to the translation direction (T).

2. The screen assembly of claim 1, further comprising a translational drive unit coupled to the screen component and configured for moving the screen component with respect to the base component along the translation direction (T).

3. The screen assembly of claim 1, further comprising a first rotational drive unit coupled to the screen component and configured for tilting the screen component with respect to the base component around the tilting axis (R1).

4. The screen assembly of claim 1, further comprising a second rotational guiding means kinematically arranged between the screen component and the base component such that the screen component is rotatable relative to the base component around a rotation axis (R2), wherein the second rotational guiding means, the first rotational guiding means and a vertical guiding means are independent from one another and the rotation axis (R2) is perpendicular to the tilting axis (R1).

5. The screen assembly of claim 4, further comprising a second rotational drive unit coupled to the screen component and configured for rotating the screen component with respect to the base component around the rotation axis (R2).

6. A method for controlling a position of a screen component in an interior of a vehicle, the method comprising:
receiving information describing a position of at least one eye of a driver being located in the interior of the vehicle;
determining a target position for the screen component as a function of the position of the at least one eye, wherein the target position is arranged within a field of view of the driver; and
moving the screen component to the target position.

7. The method of claim 6, wherein the target position is characterized in that a height difference (H) between the position of the at least one eye and the screen component is at least one of below an upper height difference threshold and above a lower height difference threshold.

8. The method of claim 6, wherein the target position is characterized in that a vision angle (α) between a horizontal direction and a vision direction (V) connecting the at least one eye and a center of a screen unit of the screen component is at least one of below an upper vision angle threshold and above a lower vision angle threshold.

9. The method of claim 6, wherein the target position is characterized in that a reflection angle (β) between a screen unit of the screen component and a windshield is at least one of below an upper reflection angle threshold and above a lower reflection angle threshold.

10. The method of claim 6, further comprising receiving information describing a position of at least one hand of the driver being located in the interior of the vehicle, and determining the target position for the screen component as a function of the position of the at least one hand.

11. The method of claim 6, further comprising receiving information describing the presence of a front seat passenger, and determining the target position of the screen component as a function of the presence of the front seat passenger.

12. A data processing apparatus, comprising:
a first communication interface configured to provide a positioning request to a screen component in an interior of a vehicle;
a second communication interface configured to receive information characterizing a position of at least one eye of a driver; and
a memory storing instructions executed by a processor to:
receive the information characterizing the position of the at least one eye of the driver being located in the interior of the vehicle;
determine a target position for the screen component as a function of the position of the at least one eye, wherein the target position is arranged within a field of view of the driver; and
move the screen component to the target position.

13. The data processing apparatus of claim 12, further comprising one or more of:
a third communication interface configured to receive information characterizing a position of at least one hand of the driver; and
a fourth communication interface being configured to receive information describing a presence of a front seat passenger,
wherein the positioning request is based on a corresponding one or more of the position of the at least one hand of the driver and the presence of the front seat passenger.

14. A screen system for an interior of a vehicle, the screen system comprising:
a screen assembly, comprising:
a base component configured for being arranged in an interior of an instrument panel or in an interior of a center console of the vehicle;
a screen component comprising a screen unit configured for displaying information for a user of the vehicle;
a translational guiding means kinematically arranged between the screen component and the base component such that the screen component is translationally movable relative to the base component along a translation direction (T);
a first rotational guiding means kinematically arranged between the screen component and the base component such that the screen component is tiltable relative to the base component around a tilting axis (R1);
wherein the first rotational guiding means and the translational guiding means are independent from one another and the tilting axis (R1) is perpendicular to the translation direction (T); and
a data processing apparatus coupled to the screen assembly, the data processing apparatus comprising:
a first communication interface configured to provide a positioning request to the screen component of the screen assembly;
a second communication interface configured to receive information characterizing a position of at least one eye of a driver; and
a memory storing instructions executed by a processor to:
receive the information characterizing the position of the at least one eye of the driver being located in the interior of the vehicle;
determine a target position for the screen component as a function of the position of the at least one eye, wherein the target position is arranged within a field of view of the driver; and
move the screen component to the target position.

15. The screen system of claim 14, further comprising an eye tracking unit configured to provide the information characterizing the position of at least one eye of the driver, the eye tracking unit being communicatively connected to the data processing apparatus via the second communication interface.
